(19) United States
(12) Patent Application Publication
(10) Pub. No.: US 2017/0124019 A1
(43) Pub. Date: May 4, 2017

(54) DISAGGREGATION OF SERVER COMPONENTS IN A DATA CENTER

(71) Applicant: Facebook, Inc., Menlo Park, CA (US)

(72) Inventors: Giovanni Coglitore, Saratoga, CA (US); Amir Meir Michael, San Mateo, CA (US); Matt Corddry, Mountain View, CA (US)

(21) Appl. No.: 15/409,475

(22) Filed: Jan. 18, 2017

Related U.S. Application Data
(62) Division of application No. 13/709,004, filed on Dec. 9, 2012.

(51) Int. Cl. G06F 13/42; G06F 1/32

(52) U.S. Cl. CPC G06F 13/4282; G06F 1/3287; G06F 1/3296; G06F 2213/0026

(57) ABSTRACT

In a data center, components of a server are located on a different circuit board than the processor. For example, components such as a network interface controller, storage devices, power supply, and memory are located on one or more circuit boards different than the circuit board on which the processor is located. Having server components on different circuit boards allows the components to be updated on different schedules, reducing resource consumption caused from tying component updates to processor updates. Locating server components on separate server boards also allows virtualization of server components included in a server rack.

### CROSS REFERENCE TO RELATED APPLICATIONS

This application is a divisional of U.S. application Ser. No. 13/709,004, filed on Dec. 9, 2012, which is incorporated by reference in its entirety.

### BACKGROUND

This invention relates generally to data centers, and more particularly to disaggregating components of servers used in a data center.

Conventional servers have multiple components coupled to a single motherboard. For example, processers, network interface controllers, memory, and other components are coupled to the motherboard and communicate with each other via the motherboard. However, this configuration increases the time used to upgrade or otherwise replace server components. Additionally, upgrading or replacing a conventional server component often requires upgrading or replacing other components in the server because they are all coupled to a single motherboard. For example, to upgrade a server processor, multiple other server components typically need to be replaced as well because they are also coupled to the same motherboard as the server processor.

### SUMMARY

In a data center, a processor of a server is coupled to a motherboard while other components of the server of coupled to one or more circuit boards different from the motherboard. For example, components such as a network interface controller, storage devices, power supply, and memory are located on one or more circuit boards while the processor is located on a motherboard separate from the circuit boards. Having server components on different circuit boards allows the components to be updated on different schedules, reducing resource consumption caused from tying component updates to processor updates. Locating server components on separate server boards also allows virtualization of server components included in a server rack.

### BRIEF DESCRIPTION OF THE DRAWINGS

FIG. 1 is a block diagram of a system for disaggregating components of a server, in accordance with an embodiment.

FIG. 2 is a block diagram of another system for disaggregating components of servers within a data center, in accordance with an embodiment.

The figures depict various embodiments of the present invention for purposes of illustration only. One skilled in the art will readily recognize from the following discussion that alternative embodiments of the structures and methods illustrated herein may be employed without departing from the principles of the invention described herein.

### DETAILED DESCRIPTION

### Overview

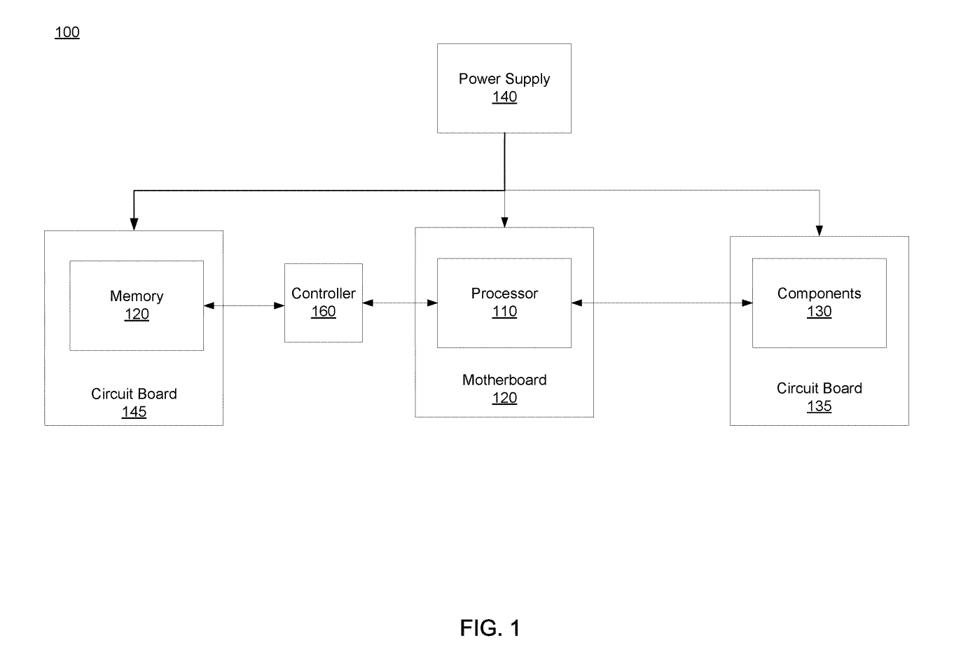

FIG. 1 is a block diagram of an embodiment for disaggregating components of a server 100 used in a data center. The server 100 includes a processor 110, a memory 120, and one/or more components 130. Examples of components 130 include a network interface controller, a storage device, an accelerator, or any other suitable component for data processing and/or communication. The memory 120 may be dynamic random access memory (DRAM) or may have another suitable configuration allowing rapid retrieval of stored data. Examples of the memory 120 include double data rate type four synchronous dynamic random access memory (DDR4 SDRAM), double data rate type three synchronous dynamic random access memory (DDR3 SDRAM), double data rate type two synchronous dynamic random access memory (DDR2 SDRAM), or other suitable configurations.

To allow different elements of the server 100 to be replaced or repaired at different times, the processor 110 is coupled to a motherboard 120, while the memory 120 is coupled to a circuit board 145 that is separate from the motherboard 120. Additionally, one or more of the components 130 are coupled an additional circuit board 135 that is separate from the motherboard 120 and from the circuit board 145. In other embodiments, the memory and one or more components 130 are coupled to a circuit board 145 separate from the motherboard 120. The motherboard 120 and a circuit board 135, 145 may be positioned at different locations within a data center, providing physical separation between the motherboard 120 and a circuit board 135, 145. A power supply 140 provides power to the motherboard 120 and to the circuit boards 135, 145 to operate elements coupled to the motherboard 120 or to a circuit board 135, 145. While FIG. 1 shows a single power supply 140, in other embodiments, multiple power supplies 140 may be used, with different power supplies connected to one or more circuit boards 135, 145

The processor 110 is coupled to the memory 120 and to one or more of the components 130, allowing data to be exchanged between the processor 110 and the memory as well as between the processor 110 and one or more components 130. In one embodiment, the processor 110 is coupled to one or more of the components 130 using a Peripheral Component Interconnect Express (PCIe) connection. However, in other embodiments, the processor 110 may be coupled to one or more components 130 using any suitable type of connection or may be coupled to different components 130 using different types of connections.

The memory 120 is coupled to the processor 110 via an optical connection or another connection capable of communicating data between the processor 110 and the memory 120 at a sufficient speed. In the embodiment shown by FIG. 1, the memory 120 is coupled to a controller 160, which is coupled to the processor 110. The controller 160 may include partitioning logic for identifying addresses in the memory 120 where data is stored or from which data is retrieved and communicated to the processor 160. In an embodiment, multiple processors 110 are coupled to the controller 160, allowing the multiple processors 110 to access different partitions of the memory 120; this allows different processors 110 to act as different logical entities sharing the memory 120. Partitioning logic in the controller 160 identifies partitions of the memory 120 corresponding to addresses received from the different processors 110.

Having the processor 110 located on a motherboard 125 separate from the circuit boards 135, 145 on which the memory 120 and/or components 130 are located allows the processor 110, memory 120, and components 130 to be updated or replaced on different schedules. For example, the processor 110 may be upgraded, while allowing continued use of the current memory 120. In contrast, conventional servers require various elements of the server to be updated as a group, so a processor upgrade causes upgrading of memory and other elements. Hence, locating the processor 110, the memory 120 and/or components 130 on a motherboard 125 and one or more different circuit boards 135, 145 allows for more efficient replacement of server elements.

Because the processor 110 of the server 100 is coupled to the motherboard 125 while one or more components 130 are coupled to a circuit board 135 separate from the motherboard 125, the processor 110 may be removed from the motherboard 125 without affecting operation of the one or more components 130. An alternate processor is coupled to the motherboard 125 and begins communicating with the one or more components 130 via connections between the motherboard 125 and the circuit board 135. Similarly, the processor 110 may remain coupled to the motherboard 125 and a component 130 is removed from the circuit board 135. An alternative component may be coupled to the circuit board 135 and communicates with the processor 110 via connections between the motherboard and the circuit board 135. Hence, one of the processor 110 or a component 135 may be replaced without replacing or interrupting operation of the other.

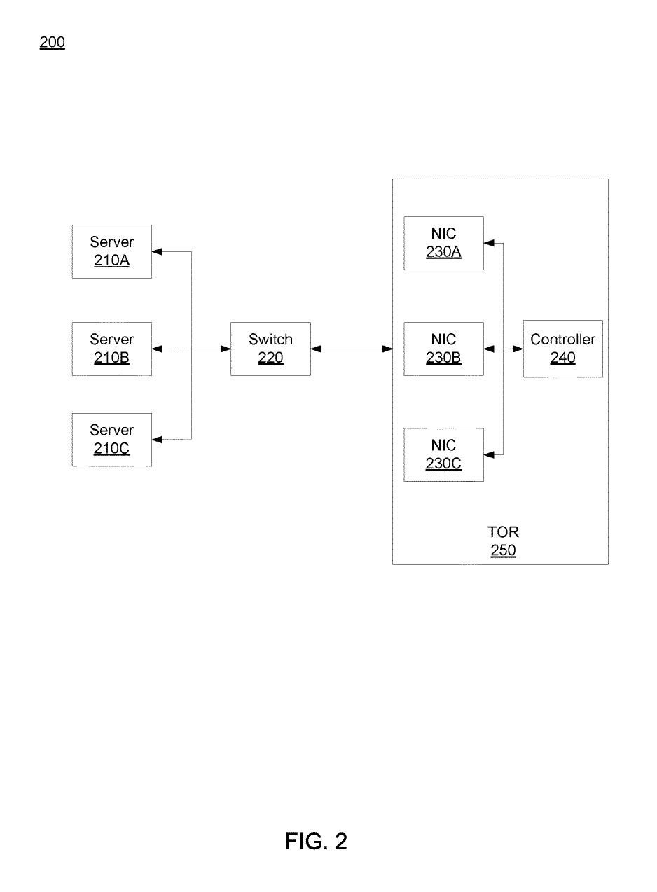

FIG. 2 is a block diagram of one embodiment of a system 200 for disaggregating components of servers. In the embodiment shown by FIG. 2, a plurality of servers 210A, 210B, 210C (also referred to individually and collectively using reference number “210”) are coupled to a switch 220. In one embodiment, the servers 210 are included in a rack within a data center.

The switch 220 routes data between one or more servers 210 and one or more network interface controllers (NICs) 230A, 230B, 230C (also referred to individually and collectively using reference number “230”). In one embodiment, the switch 220 receives data from a server 210A and directs the data to a NIC 230A associated with the server 210A or to a NIC 230. In one embodiment, switch 220 is coupled to the one or more servers 210 using a Peripheral Component Interconnect Express (PCIe) connection. The switch may also be coupled to the one or more NICs 230 using a PCIe connection. Alternatively, one or more servers 210 are coupled to the switch 220 using a mini-serial attached small computer system interface (mini-SAS) connection and the switch is coupled to one or more NICs 230 using a PCIe connection. However, in other embodiments, the switch may be coupled to the servers 210 and to the NICs 230 using any suitable type, or types, of connections.

The one or more NICs 230 are external to the one or more servers 210 and may be positioned in a location of a data center separate from a location of the one or more servers 210. In the embodiment shown by FIG. 2, the NICs 230 are included in a top of the rack (TOR) switch 250 near a top of a data center rack. A NIC 230 communicates data received from a server 210 via the switch 220 to a network and communicates data received from the network to a server 210 via the switch 220. A controller may be coupled to each of the one or more NICs 230 to regulate communication of data between the network and the one or more NICs 230; the controller may be implemented in software or firmware to regulate network traffic to and from various NICs 230.

In one embodiment, the switch 220 directs data from multiple servers 210 to a NIC 230, so the NIC 230 communicates data received from multiple servers 210 to the network. Data received by the NIC 230 is communicated to the switch 220, which identifies a server 210 from the received data and communicates the data to the identified server 210. For example, thirty severs 210 are coupled to the switch 220, which communicates data from the thirty servers to a single NIC 230. This allows multiple servers 210 to use a single NIC 230, providing more efficient resource usage.

Additionally, separating NICs 230 from servers 210 allows the servers 210 to be replaced or upgraded independently of the NICs 230. This allows the NICs 230 to be re-used even as servers 210 are replaced or upgraded, reducing costs of upgrading or replacing servers. Further, the system 220 allows multiple servers 210 to share a NIC 230, allowing the system 200 to use fewer, higher-capacity NICs 230 without impairing server performance.

### SUMMARY

The foregoing description of the embodiments of the invention has been presented for the purpose of illustration; it is not intended to be exhaustive or to limit the invention to the precise forms disclosed. Persons skilled in the relevant art can appreciate that many modifications and variations are possible in light of the above disclosure.

Some portions of this description describe the embodiments of the invention in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments of the invention may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments of the invention may also relate to a product that is produced by a computing process described herein. Such a product may comprise information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

What is claimed is:

1. A system comprising:
a processor coupled to a motherboard;
a component coupled to a circuit board separate from the motherboard, the component configured to exchange data with the processor and selected from a group consisting of: a network interface controller, an accelerator, and any combination thereof; and
one or more power supplies coupled to the processor and to the component and configured to supply power to the processor and to the component.

2. The system of claim 1, wherein the component is configured to exchange data with the processor using a Peripheral Component Interconnect Express (PCIe) connection.

3. The system of claim 1, wherein the motherboard and the circuit board are at different locations within a data center.

4. The system of claim 1, further comprising:
a memory coupled to an additional circuit board separate from the motherboard;
a controller coupled to the memory and to the processor, the controller configured to retrieve data from locations in the memory and communicate the retrieved data to the processor.

5. The system of claim 1, further comprising:
an additional processor coupled to an additional motherboard and coupled to the controller; and
the controller further configured to identify partitions of the memory associated with each of the processor and the additional processor and to communicate data from the identified partitions to the processor or to the additional processor.

6. A method comprising:
coupling a processor to a motherboard;
coupling a component to a circuit board separate from the motherboard to which the processor is coupled;
coupling the component to the processor for communicating data between the component and the processor, the component elected from a group consisting of: a network interface controller, an accelerator, and any combination thereof; and
replacing the motherboard with an alternative motherboard including an alternative processor without removing the component from the circuit board separate from the motherboard.

7. A method comprising:
coupling a processor to a motherboard;
coupling a component to a circuit board separate from the motherboard to which the processor is coupled;
coupling the component to the processor for communicating data between the component and the processor;
removing the component from the circuit board without removing the processor from the motherboard; and
coupling an alternative component to the circuit board.

8. The method of claim 7, wherein the component is selected from a group consisting of: a network interface controller, a storage device, an accelerator, and any combination thereof.
